(19) United States
(12) Patent Application Publication
(10) Pub. No.: US 2010/0297488 A1
(43) Pub. Date: Nov. 25, 2010

(54) EXPLOSION-PROOF STRUCTURE OF POWER SOURCE PART, EXPLOSION-PROOF TYPE BATTERY UNIT AND EXPLOSION-PROOF TYPE GAS ALARM

(75) Inventors: Shuji Tajima, Tokyo (JP); Haruhiko Kondo, Tokyo (JP); Masahide Kitamura, Tokyo (JP); Kei Ono, Tokyo (JP)

Correspondence Address: HOLTZ, HOLTZ, GOODMAN & CHICK PC, 220 Fifth Avenue, 16TH Floor, NEW YORK, NY, 10001-7708, US

(73) Assignee: Riken Keiki Co., Ltd., Tokyo (JP)

(21) Appl. No.: 12/864,263

(22) PCT Filed: Jan. 26, 2009
(86) PCT No.: PCT/JP2009/051183

§ 371 Date: Jul. 23, 2010

(30) Foreign Application Priority Data
Jan. 29, 2008 (JP) 2008-017577

(51) Int. Cl. H01M 10/50

(52) U.S. Cl. 429/120

(57) ABSTRACT

Provided is an explosion-proof structure of a power source part, an explosion-proof type battery unit and an explosion-proof type gas alarm, in which the degree of temperature rise upon short circuit of a secondary battery is reduced and explosion-proof performance with high reliability is achieved. The explosion-proof structure of a power source in an explosion-proof type apparatus employing a secondary battery as a power source for driving is fabricated by arranging a heat-radiating member composed of a metal at an outer peripheral surface of the secondary battery in a state that at least a part thereof comes into close contact with the surface. The explosion-proof type battery unit is composed of a cylindrical secondary battery and a heat-radiating member composed of a metal provided at an outer peripheral surface of the secondary battery in a state that at least a part thereof comes into close contact with the surface. The explosion-proof type gas alarm is fabricated by using the explosion-proof type battery unit or providing the heat-radiating member in a housing in a gas alarm body to form the explosion-proof structure of the power source part.

TECHNICAL FIELD

The present invention relates to an explosion-proof structure of a power source part in an explosion-proof type apparatus employing a secondary battery as a power source for driving, an explosion-proof type battery unit and an explosion-proof type gas alarm.

### BACKGROUND ART

There are generally frequent occasions when it may be possible in, for example, underground job sites or gateways, or other places where persons enter, or working regions that air in an environmental atmosphere is in a dangerous state, or will become a dangerous state, such as occasions when hazardous gas such as carbon monoxide, hydrogen sulfide gas or the like may possibly be contained in air in such an environment, or when the oxygen gas concentration in air may possibly be lowered.

When the air in the environmental atmosphere has become a dangerous state to persons due to high concentration of the dangerous gases contained or low oxygen gas concentration therein, it is necessary for a worker or the like to immediately sense the fact. From such a demand, there have heretofore been proposed various types of portable gas alarms.

In recent years, it has been desired to reduce the use of dry cells as much as possible because consciousness about environmental protection has increased, and so in such a portable gas alarm, for example, a secondary battery has been built-in as a power source for driving so as to permit repeated use thereof by conducting a charging operation.

However, such a portable gas alarm is used under an environment having a danger of firing or explosion due to the presence of an explosive atmosphere containing combustible gases and/or vapors, so that the gas alarm itself is required to have a construction that does not become a firing source, i.e., a construction satisfying the standard of the so-called explosion-proof specification.

In, for example, a power source part, it is required that the surface temperature of a secondary battery does not rise to a temperature higher than a certain temperature upon short circuit of the battery, and an electrolytic solution contained therein does not leak, and various constructions have been proposed as the explosion-proof structure of, for example, the power source part (secondary battery) (see, for example, Patent Art. 1).

However, a high-capacity secondary battery composed of, for example, a single-4 type (AAA-size) nickel-hydrogen battery has heretofore been great in the degree of temperature rise upon the short circuit, and inconveniences such as leakage of the electrolytic solution have occurred. It has thus been difficult to use such a secondary battery in an explosion-proof gas alarm of which an explosion-proof structure has been required. In, for example, a nickel-hydrogen battery, surface temperature of the battery upon short circuit may reach, for example, 200° C. in some cases.
Patent Art. 1: Japanese Patent Application Laid-Open No. 2001-216944

### DISCLOSURE OF THE INVENTION

### Problems Sought For Solution By the Invention

The present invention has been made on the basis of the foregoing circumstances and fundamentally has as its object the provision of an explosion-proof structure of a power source part and an explosion-proof type battery unit, in which the degree of temperature rise upon short circuit of a secondary battery can be reduced and explosion-proof performance with high reliability is achieved.

Another object of the present invention is to provide an explosion-proof type gas alarm, in which an explosion-proof structure for a power source part composed of a secondary battery is achieved with high reliability.

### Means For the Solution of the Problems

The present invention provides an explosion-proof structure of a power source part in an explosion-proof type apparatus employing a secondary battery as a power source for driving, wherein

a heat-radiating member composed of a metal is arranged at an outer peripheral surface of the secondary battery in a state that at least a part thereof comes into close contact with the surface.

The present invention also provides an explosion-proof type battery unit comprising a cylindrical secondary battery and a heat-radiating member composed of a metal provided at an outer peripheral surface of the secondary battery in a state that at least a part thereof comes into close contact with the surface.

In the explosion-proof type battery unit according to the present invention, a nickel-hydrogen battery may be employed as the secondary battery.

In the explosion-proof type battery unit according to the present invention, the heat-radiating member may preferably be in the form of a sleeve and provided in a state coming into close contact with the whole outer peripheral surface of the secondary battery, and a material forming the heat-radiating member may preferably be aluminum.

The present invention further provides an explosion-proof type gas alarm employing a secondary battery as a power source for driving, which comprises the above-described explosion-proof type battery unit.

In this explosion-proof type gas alarm, it may be preferable that the explosion-proof type battery unit be held by a frame-like holder member, and arranged in a state that the heat-radiating member comes into no contact with a housing in a gas alarm body.

The present invention still further provides an explosion-proof type gas alarm comprising a housing, in the interior of which a battery-arranging part housing a secondary battery that is a power source for driving has been formed, wherein

a heat-radiating member composed of a metal is provided in the battery-arranging part, and a secondary battery is arranged in the battery-arranging part, whereby the above-described explosion-proof structure is formed.

### Effects of the Invention

In an explosion-proof type apparatus, a secondary battery is considered to short-circuit due to the structure thereof, and it is required that the surface temperature of the secondary battery upon short circuit is kept at a certain temperature or lower. According to the explosion-proof structure of the power source part in the explosion-proof type apparatus of the present invention, the heat-radiating member composed of the metal is arranged at an outer peripheral surface of the secondary battery in a state that at least a part thereof comes into close contact with the surface, and heat generated upon the short circuit is radiated through the heat-radiating member, whereby the degree of rise of the surface temperature of the secondary battery upon the short circuit can be reduced, and so the explosion-proof type apparatus comes to have a prescribed explosion-proof performance.

According to the explosion-proof type battery unit of the present invention, in which the above-described explosion-proof structure is formed, the prescribed explosion-proof structure as to a secondary battery can be achieved by a simple construction that a pipe material having an inner diameter conforming to an outer diameter of the secondary battery is installed, and so the battery unit can be extremely easily fabricated.

In addition, the explosion-proof type battery unit is used, whereby the explosion-proof structure of a power source part can be achieved without adopting a particular structure in an explosion-proof type apparatus body, so that the battery unit can be fabricated with high accessibility.

A high-capacity secondary battery composed of, for example, a nickel-hydrogen battery can be employed, and so the battery unit becomes extremely useful as a power source for driving of an apparatus fabricated as a portable type.

According to the explosion-proof type gas alarm of the present invention, the above-described explosion-proof battery unit is employed, or the heat-radiating member is provided in the battery-arranging part in the housing, whereby the above-described explosion-proof structure is formed, so that the explosion-proof structure for a power source part is achieved with high reliability.

### BRIEF DESCRIPTION OF THE DRAWINGS

FIG. 1 is a front elevation illustrating the construction of an explosion-proof type gas alarm according to an embodiment of the present invention.

FIG. 2 is a top view of the explosion-proof type gas alarm illustrated in FIG. 1.

FIG. 3 is a cross-sectional view taken along line B-B in FIG. 1.

FIG. 4 is a cross-sectional view taken along line C-C in FIG. 2.

FIG. 5 illustrates the construction of an explosion-proof type battery unit according to the present invention, in which (a) is a plan view, and (b) is an end view viewed from outward in an axial direction of a secondary battery.

FIG. 6 is an exploded perspective view of the explosion-proof type battery unit illustrated in FIG. 5.

### BEST MODE FOR CARRYING OUT THE INVENTION

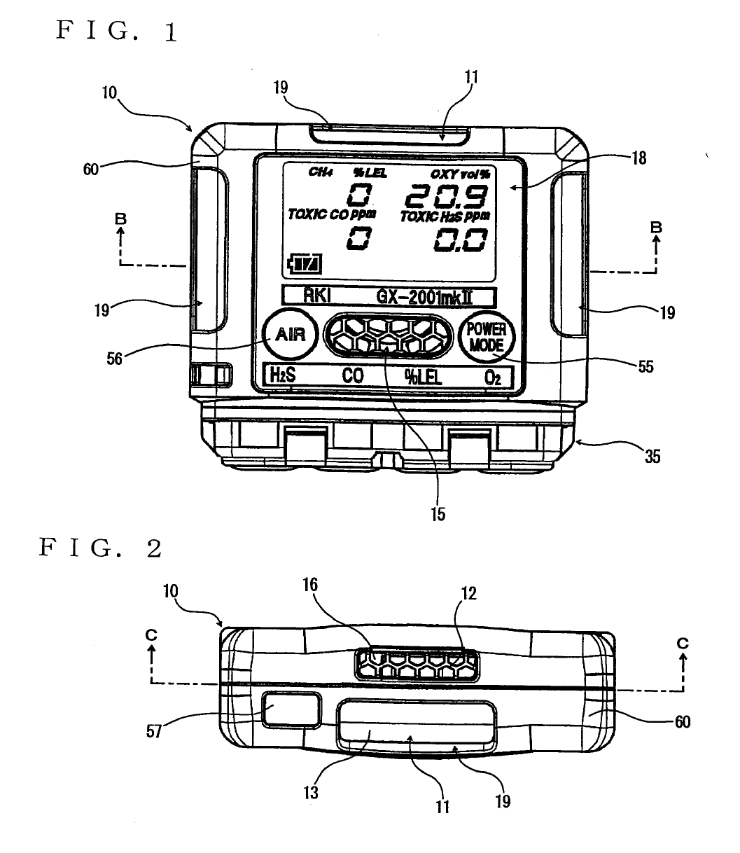

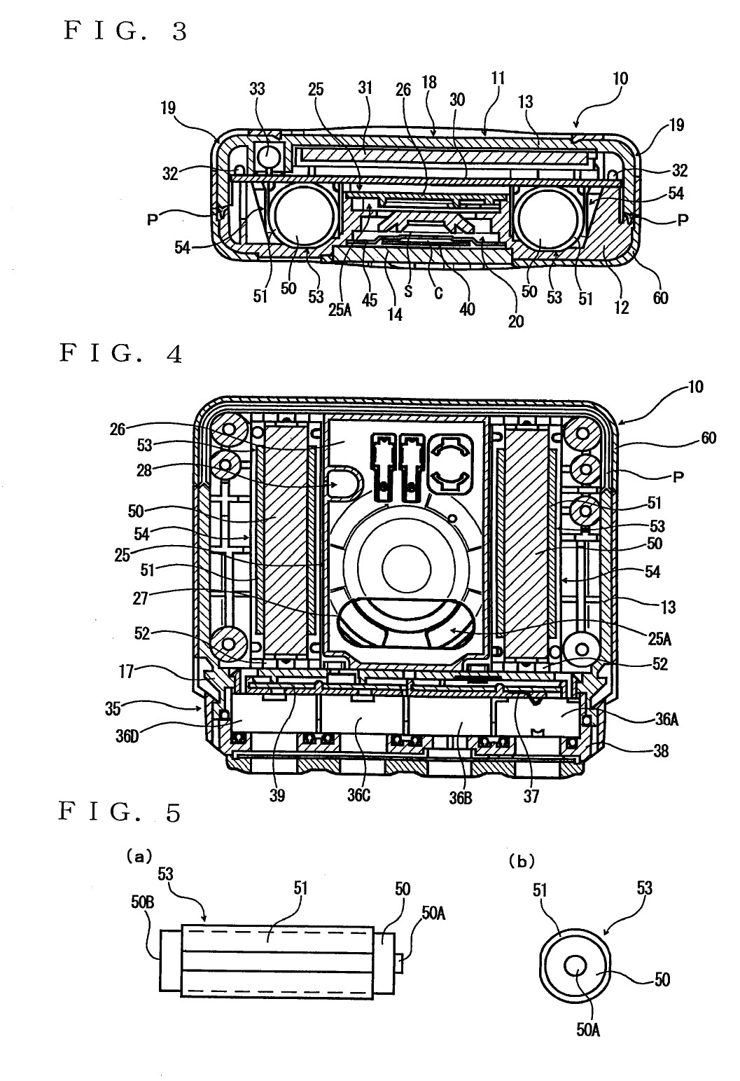

FIG. 1 is a front elevation illustrating the construction of an explosion-proof type gas alarm according to an embodiment of the present invention, FIG. 2 is a top view of the explosion-proof type gas alarm illustrated in FIG. 1, FIG. 3 is a cross-sectional view taken along line B-B in FIG. 1, and FIG. 4 is a cross-sectional view taken along line C-C in FIG. 2.

This explosion-proof type gas alarm 10 is equipped with a housing 11 in the form of a substantial box type as a whole, which is composed of a back-surface-side housing member 12 and a front-surface-side housing member 13 joined and fixed to the back-surface-side housing member 12 through a packing P and formed of, for example, a transparent resin material. This housing 11 has a size capable of being grasped and held with a hand.

In the interior of the housing 11, a flat plate-like circuit board 30 for operation control, on which necessary various function elements have been mounted is arranged in such a manner that a front surface thereof faces a front face of the housing 11. A panel-like display mechanism 31 is provided in a central region on the front surface side of the circuit board 30 for operation control, and on the back surface side thereof, a partition chamber 25 having a cavity portion 25A divided from a space, in which electronic parts such as the circuit board 30 for operation control are arranged, in a water tight state to each other is formed. Explosion-proof type battery units 53 each including a secondary battery (storage battery) 50, which will be described subsequently, are arranged on both left and right sides of this partition chamber 25.

Under the housing 11, is formed a sensor unit installing part 17, in which a sensor unit 35 held in a fixed state by a sensor holder 37, in which sensor holding parts respectively holding, for example, four button type gas sensors detecting gases different from one another in a state that the gas sensors are aligned in a plane direction have been formed, and a sensor cap 38, in the interior of which gas passages communicating to the respective sensor holding parts have been formed, is detachably installed. Character 39 denotes a sensor board.

As examples of the gas sensors, may be mentioned a gas sensor 36A for detection of oxygen gas composed of, for example, a galvanic type gas sensor element, a gas sensor 36B composed of, for example, a catalytic combustion type gas sensor element and detecting hydrocarbon gasses in a measuring range of % LEL (lower explosive limit concentration), a gas sensor 36C for detection of carbon monoxide gas composed of, for example, a controlled potential electrolysis gas sensor element, and a gas sensor 36D for detection of hydrogen sulfide gas composed of, for example, a controlled potential electrolysis gas sensor element.

At a position corresponding to the partition chamber 25 on the back surface side of the housing 11, is formed a buzzer arranging chamber 20 composed of, for example, a concavity of a 3-step staircase form, which forms a substantially cylindrical space that the diameter thereof becomes smaller toward the front face side, and a lid member 14 is provided so as to close the buzzer arranging chamber 20.

A buzzer 40 is formed by, for example, a thin plate-like piezoelectric element composed of a vibrator with a disc-like piezoelectric ceramic stuck at a central portion on a surface of a disc-like metal plate, and is arranged in a state not directly fixed to the housing 11 by a filmy cushioning member 45. More specifically, a peripheral edge portion of the metal plate is fitted to the cushioning member 45 composed of a resin and fixed in a state that a cavity C has been formed at a central portion, and the cushioning member 45 is fixed to the housing 11 at a peripheral edge portion thereof in a state interposing a cavity S at a position corresponding to a position, at which the buzzer 40 is arranged, between the cushioning member 45 and the housing 11.

The cushioning member 45 is preferably formed by, for example, a material having anti-water permeability, and as examples of such a material, may be mentioned polycarbonate (PC), polyethylene terephthalate (PET) and polyvinyl chloride (PVC).

The thickness of the cushioning member 45 is preferably, for example, 0.1 to 0.4 mm, whereby a sufficient cushioning function is achieved, and moreover deformability sufficient to follow the vibration of the metal plate in the buzzer 40 is achieved.

A space portion 28 communicating the buzzer arranging chamber 20 to the internal space of the housing 11, specifically, the space, in which the electronic parts such as the circuit board 30 for operation control are arranged, is formed at a position close to the buzzer arranging chamber 20 on the back surface side of the housing 11 independent of the cavity portion 25A in the partition chamber 25, and a lead (not illustrated) connecting the buzzer 40 to the circuit board 30 for operation control is arranged in the space portion 28.

On the other hand, in the partition chamber 25 in the interior of the housing 11, a front-surface-side opening portion of a partition wall formed so as to surround four sides of a position corresponding to the buzzer arranging chamber 20 in an inner face of the back-surface-side housing member 12 is closed by a partition wall 26, whereby the cavity portion (tunnel portion) 25A is formed in the interior.

A cylindrical portion 27 in the sectional form of a substantial ellipse is formed at a lower position in the partition wall 26, and the cylindrical portion 27 is fitted through a packing in an opening for emitting alarm sound (hereinafter referred to as “forward sound emitting opening”) 15 formed at a lower position of a display part 18 in the front-surface-side housing member 13, whereby the internal space of the partition chamber 25 is communicated to the outside through a dust-proof net (not illustrated) provided at the forward sound emitting opening 15.

The internal space of the partition chamber 25 is communicated to the outside through an opening for emitting alarm sound (hereinafter referred to as “upward sound emitting opening”) 16 formed in a top wall of the back-surface-side housing member 12 forming a part of the partition chamber 25, and a dust-proof net (not illustrated) provided at the upward sound emitting opening 16.

In this explosion-proof type gas alarm 10, alarm warning mechanisms by light emission of a light emitting element 32 for warning and vibration of a vibration generator 33 for warning are provided in addition to an alarm warning mechanism by buzzer sound (see FIG. 3).

In the explosion-proof type gas alarm 10, a protecting cover 60 composed of, for example, a conductive thermoplastic elastomer composition is fitted, and in a state that the protecting cover 60 has been fitted, the size of a continuous resin surface portion of the housing 11 exposed to the outside is restricted to a predetermined size, for example, at most 100 cm², whereby the gas alarm comes to have sufficient countermeasure to static electricity and explosion-proofness with high reliability. Since the protecting cover 60 also functions as a buffering material (protecting material) of the explosion-proof type gas alarm 10 by the shock resistance of the material itself forming the protecting cover 60, the explosion-proof type gas alarm 10 can be prevented from being troubled or broken to retain a proper operating state.

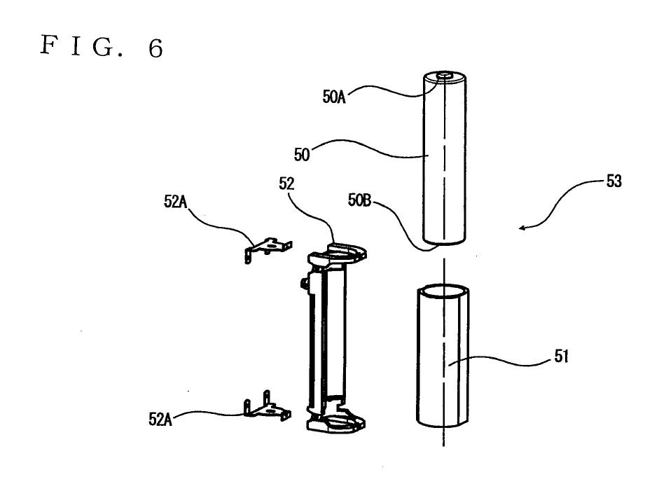

As a power source for driving in the explosion-proof type gas alarm as above, is employed an explosion-proof type battery unit 53 constructed by a cylindrical secondary battery (storage battery) 50 of, for example, an AAA-size (single-4 type) and a sleeve-like heat-radiating member 51 composed of a metal provided in a state coming into close contact with the outer peripheral surface of the secondary battery 50 as illustrated in FIGS. 5(a) and (b) and FIG. 6.

This explosion-proof type battery unit 53 is held by a frame-like holder member 52 in a state that a positive terminal 50A and a negative terminal 50B at both ends of the secondary battery 50 have been exposed from the heat-radiating member 51, and in this state, is arranged in a battery-arranging part 54 in the housing 11 in a state the outer peripheral surface of the heat-radiating member 51 comes into no contact with the inner surface of the housing 11. By such construction, the heat-radiating member 51 can ensure sufficient heat-radiating ability. Character 52A in FIG. 6 denotes an armature terminal.

The thickness of the heat-radiating member 51 is preferably, for example, 0.1 to 0.4 mm.

As examples of the secondary battery 50, may be mentioned a nickel-hydrogen (NiMH) battery and a nickel-cadmium (NiCd) battery, and in this explosion-proof type gas alarm 10, for example, a battery having a rated voltage of 1.2 V and a capacity of 800 mA is used.

In FIG. 1, character 55 denotes a first operating button, on which “POWER” and “MODE” are displayed in two lines, and which combines a main switch and a mode change-over switch. Character 56 denotes a second operating button, on which “AIR” is displayed, and which is used for function control to change the standard of alarm generation according to the kind of a gas sensor, i.e., the kind of a gas intended to be detected by the gas sensor. Character 19 denotes a light emitting part for warning formed in each of regions of the front face of the housing 11, and the top face and both side faces contiguous thereto. In FIG. 2, character 57 denotes an infrared communication port for reading out gas concentration data recorded in a memory element of the circuit board 30 for operation control by, for example, detection by a gas sensor.

In the explosion-proof type gas alarm 10 of the above-described construction, air in an environmental atmosphere diffuses to reach the gas sensors 36A to 36D, detection of a concentration as to an intended gas is conducted, and the result thereof is displayed on the panel-like display mechanism 31. When the concentration of the gas intended to be detected has exceeded a reference value preset as to said gas, an alarm actuation signal is generated, whereby the buzzer 40 is actuated to emit alarm sound to the outside through the forward sound emitting opening 15 and the upward sound emitting opening 16.

For example, when the gas intended to be detected is oxygen gas (O₂ gas), the reference value is preset to, for example, 18.0% by volume (vol. %), and an alarm actuation signal is generated when the concentration has become lower than the reference value. When the gas intended to be detected is hydrocarbon gas (HC gas), the reference value is preset to, for example, 10% LEL (gas concentration to the lower explosive limit concentration). When the gas intended to be detected is carbon monoxide gas (CO gas), the reference value is preset to, for example, 25 ppm. When the gas intended to be detected is hydrogen sulfide gas (H₂S gas), the reference value is preset to, for example, 10 ppm. When the concentration of each of these gases intended to be detected has exceeded its corresponding reference value, an alarm actuation signal is generated.

In the explosion-proof type gas alarm 10, plural kinds of alarm warning mechanisms are provided, it is not necessary to drive all of them at a time, and it is preferable to conduct a cyclic alarm operation that the respective alarm warning mechanisms are driven by turns for a predetermined period of time.

In order to fabricate a gas alarm of the explosion-proof specification, a secondary battery is considered to short-circuit due to the structure thereof, and it is required that the surface temperature of the secondary battery upon short circuit is kept at a certain temperature or lower. According to the explosion-proof type gas alarm 10 of the above-described construction, the particular explosion-proof type battery unit 53 having the heat-radiating member 51 composed of the metal provided in close contact with the whole outer peripheral surface of the secondary battery 50 is used, whereby heat generated upon the short circuit of the secondary battery 50 is radiated through the heat-radiating member 51, so that the explosion-proof structure of a power source part capable of reducing the degree of rise of the surface temperature of the secondary battery 50 upon the short circuit can be achieved, and so the explosion-proof type gas alarm 10 comes to have explosion-proofness with sufficiently high reliability.

According to the above-described explosion-proof type battery unit 53, the prescribed explosion-proof structure as to the secondary battery 50 can be achieved by a simple construction that the heat-radiating member 51 composed of a pipe material having an inner diameter conforming to an outer diameter of the secondary battery 50 is installed, and so the battery unit can be extremely easily fabricated.

In addition, said explosion-proof type battery unit 53 is employed, whereby the explosion-proof structure of a power source part can be achieved without adopting a particular structure in an explosion-proof type gas alarm body, so that the battery unit can be fabricated with high accessibility.

In such an explosion-proof structure, a high-capacity secondary battery 50 composed of, for example, a nickel-hydrogen battery can be used, and so the battery unit becomes extremely useful as a power source for driving of an apparatus fabricated as a portable type.

Although one embodiment of the present invention has been described above, the present invention is not limited to the embodiment, and various changes or modifications can be added thereto.

For example, in the explosion-proof type gas alarm according to the present invention, a sleeve-like heat-radiating member may be provided in the battery-arranging part in the housing without using the above-described explosion-proof type battery unit to form the explosion-proof structure of the power source part. By such construction, the same action and effects as in the above-described embodiment can also be achieved.

In, for example, the explosion-proof type battery unit, the heat-radiating member is not required to come into close contact with the outer peripheral surface of the secondary battery, and for example, slits or openings may be formed therein. By such a form, the surface area of the heat-radiating member can be made larger so that still higher heat-radiating ability may be achieved.

In addition, the explosion-proof structure of the power source part according to the present invention is not limited to use in the gas alarm, and is extremely useful in apparatus driven by a battery, of which the explosion-proof specification is required.

### DESCRIPTION OF CHARACTERS

10 Explosion-proof type gas alarm

11 Housing

12 Back-surface-side housing member

13 Front-surface-side housing member

14 Lid member

15 Forward sound emitting opening (opening for emitting alarm sound)

16 Upward sound emitting opening (opening for emitting alarm sound)

17 Sensor unit installing part

18 Display part

19 Light emitting part for warning

20 Buzzer arranging chamber

25 Partition chamber

25A Cavity portion (tunnel portion)

26 Partition wall

27 Cylindrical portion

28 Space portion

30 Circuit board for operation control

31 Panel-like display mechanism

32 Light emitting element for warning

33 Vibration generator for warning

35 Sensor unit

36A, 36B, 36C, 36D Gas sensors

37 Sensor holder

38 Sensor cap

39 Sensor board

40 Buzzer

45 Cushioning member

50 Secondary battery

50A Positive terminal

50B Negative terminal

51 Heat-radiating member

52 Holder member

52A Armature terminal

53 Explosion-proof type battery unit

54 Battery-arranging part

55 First operating button

56 Second operating button

57 Infrared communication port

60 Protecting cover

P Packing

C Cavity

S Cavity

1. An explosion-proof structure of a power source part in an explosion-proof type apparatus employing a secondary battery as a power source for driving,
wherein a heat-radiating member comprising a metal is arranged at an outer peripheral surface of the secondary battery in a state that at least a part thereof comes into close contact with the surface.

2. An explosion-proof type battery unit comprising a cylindrical secondary battery and a heat-radiating member comprising a metal provided at an outer peripheral surface of the secondary battery in a state that at least a part thereof comes into close contact with the surface.

3. The explosion-proof type battery unit according to claim 2, wherein the secondary battery comprises a nickel-hydrogen battery.

4. The explosion-proof type battery unit according to claim 2, wherein the heat-radiating member is in the form of a sleeve, and is provided in a state coming into close contact with the outer peripheral surface of the secondary battery.

5. The explosion-proof type battery unit according to claim 2, wherein the heat-radiating member comprises aluminum.

6. An explosion-proof type gas alarm employing a secondary battery as a power source for driving, which comprises the explosion-proof type battery unit according to claim 2.

7. The explosion-proof type gas alarm according to claim 6, wherein the explosion-proof type battery unit is held by a frame-like holder member, and is arranged in a state that the heat-radiating member does not come into contact with a housing in a gas alarm body.

8. An explosion-proof type gas alarm comprising a housing, in the interior of which a battery-arranging part housing a secondary battery that is a power source for driving has been formed,
wherein a heat-radiating member comprising a metal is provided in the battery-arranging part, and a secondary battery is arranged in the battery-arranging part, whereby the explosion-proof structure according to claim 1 is formed.

9. An explosion-proof type gas alarm employing a secondary battery as a power source for driving, which comprises the explosion-proof type battery unit according to claim 3.

10. An explosion-proof type gas alarm employing a secondary battery as a power source for driving, which comprises the explosion-proof type battery unit according to claim 4.

11. An explosion-proof type gas alarm employing a secondary battery as a power source for driving, which comprises the explosion-proof type battery unit according to claim 5.

12. The explosion-proof type gas alarm according to claim 9, wherein the explosion-proof type battery unit is held by a frame-like holder member, and is arranged in a state that the heat-radiating member does not come into contact with a housing in a gas alarm body.

13. The explosion-proof type gas alarm according to claim 10, wherein the explosion-proof type battery unit is held. by a frame-like holder member, and is arranged in a state that the heat-radiating member does not come into contact with a housing in a gas alarm body.

14. The explosion-proof type gas alarm according to claim 11, wherein the explosion-proof type battery unit is held by a frame-like holder member, and is arranged in a state that the heat-radiating member does not come into contact with a housing in a gas alarm body.
